(19) United States
(12) Patent Application Publication
(10) Pub. No.: US 2007/0159836 A1
(43) Pub. Date: Jul. 12, 2007

(54) Solar photo-voltaic panel and light structure

(76) Inventors: Bin-Juine Huang, Taipei (TW); Min-Sheng Wu, Taoyuan Hsien (TW); Kun-Hung Lo, Taichung Hsien (TW); Po-Chien Hsu, Zhanghua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,330

(22) Filed: Jan. 6, 2006

(51) Int. Cl. F21S 13/10

(52) U.S. Cl. 362/431; 362/183; 362/414; 362/413; 362/411

(57) ABSTRACT

A solar photo-voltaic panel light structure includes a sectioned pole including a lamp formed on a upper end thereof and a foot formed on a lower end thereof to facilitate erecting the pole in the ground, a solar photo-voltaic panel battery adjustably connected to the pole and a control box electrically connected to the solar photo-voltaic panel battery so that the solar photo-voltaic panel battery is able to provide electricity.

### BACKGROUND OF THE INVENTION

1. Field of the Invention

The present invention relates to a solar photo-voltaic panel and light structure, and more particularly to a solar photo-voltaic panel and light structure that can be assembled easily.

2. Description of Related Art

There are two major reasons preventing the successful promotion of solar photo-voltaic panel lights, i.e. transportation and assembly. Because the conventional solar photo-voltaic panel light includes an integrally formed pole including a length of at least three (3) meters, transportation of the pole is inconvenient and dangerous to others, unless a special transportation vehicle is employed. Furthermore, when assembly of the solar photo-voltaic panel light is in process, a hole with a diameter of one (1) meter is first dug in the ground. After the employment of molding plate and stainless steel as a base, the hole is then filled with cement. After the cement includes cured and dried after the base of the pole is installed in the hole, the pole is ready to be mounted on the base.

Therefore, the dimension of the pole and the lengthy assembly process become negative factors that limit popularity of solar photo-voltaic panel lights.

To overcome the shortcomings, the present invention tends to provide an improved solar photo-voltaic panel light to mitigate the aforementioned problems.

### SUMMARY OF THE INVENTION

The primary objective of the present invention is to provide an improved solar photo-voltaic panel light including a sectioned pole so that the operator is able to easily transport the pole when the pole is disassembled.

In one aspect of the present invention, a sharp end is formed on the lower end of the pole to facilitate insertion of the pole into the ground.

In yet another aspect of the present invention, the solar photo-voltaic panel light structure of the present invention includes a securing device to secure the solar power battery to the pole.

A further aspect of the present invention is that the securing device includes a ring securable to the pole so that the solar power battery is able to be adjustably connected to the pole.

Other objects, advantages and novel features of the invention will become more apparent from the following detailed description when taken in conjunction with the accompanying drawings.

### BRIEF DESCRIPTION OF THE DRAWINGS

FIG. 1 is a schematic perspective view showing a solar light according to a first embodiment of the present invention;

FIG. 2 is a schematic side view showing that the solar photo-voltaic panel light is inserted into the ground;

FIG. 3 is a perspective view of the securing device of the present invention;

FIG. 4 is a schematic perspective view showing the structure of the pole of the present invention;

FIG. 5 is an exploded view of the securing device of the present invention;

FIG. 6 is an exploded view showing the components of the present invention;

FIG. 7 is a schematic side plan view showing the employment of the embodiment in FIG. 6;

FIG. 8 is a perspective view showing the structure of a portion of the pole;

FIG. 9 is a schematic side view of a solar light according to a second embodiment of the present invention;

FIG. 10 is a schematic side view showing a solar light according to a third embodiment of the present invention; and

FIG. 11 is a schematic perspective view showing a solar light according to a fourth embodiment of the present invention.

### DETAILED DESCRIPTION OF THE PREFERRED EMBODIMENT

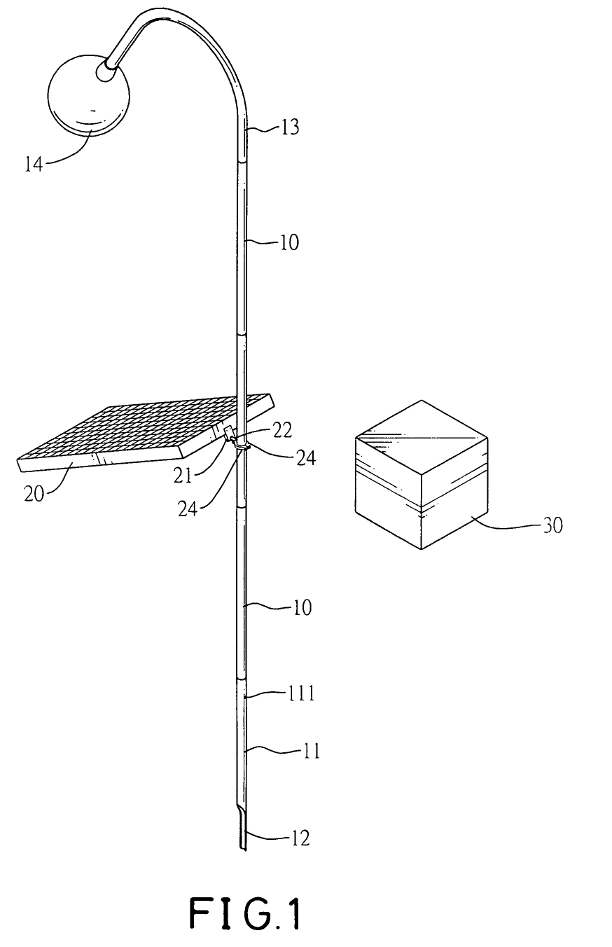

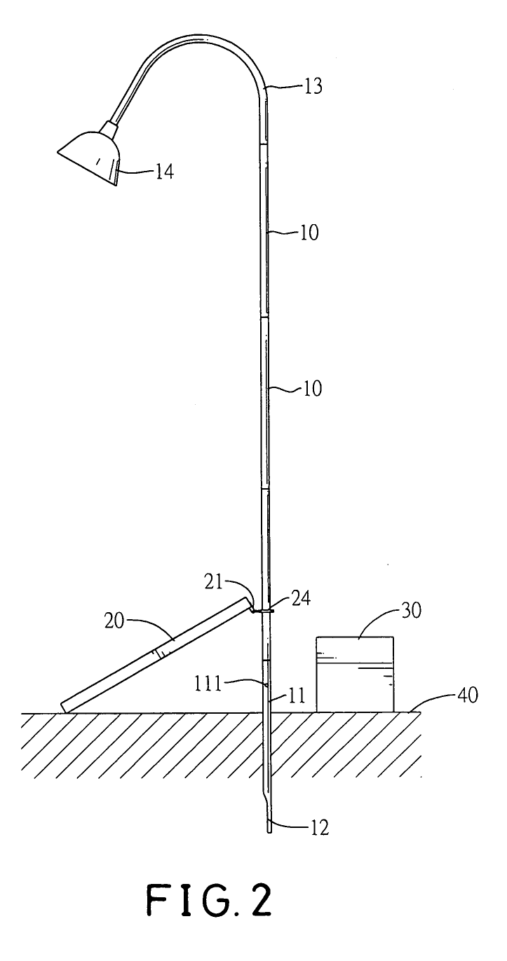

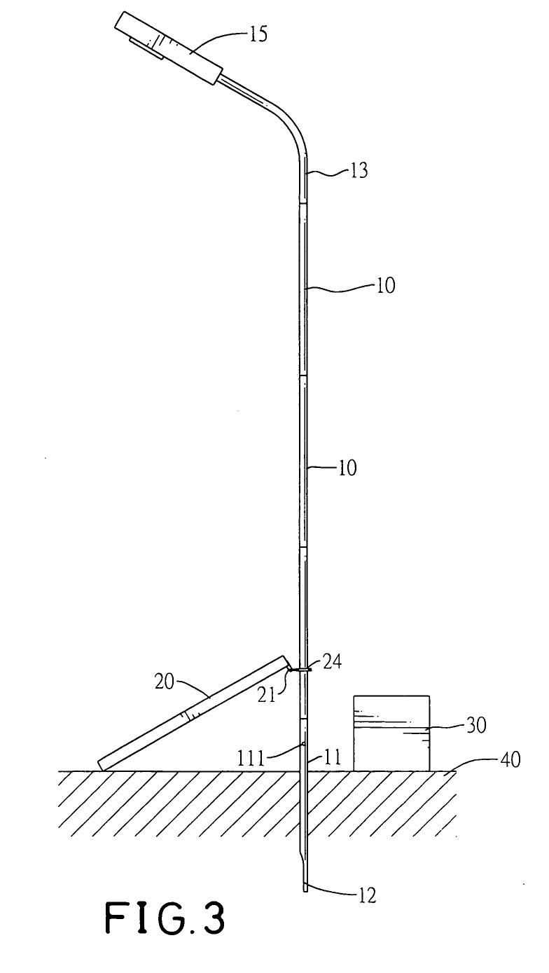

With reference to FIGS. 1, 2, 3 and 4, the solar light in accordance with a first embodiment of the present invention includes a pole (10), a solar photo-voltaic panel battery (20) and a control box (30).

The pole (10) is composed of sections correlated to one another. That is, each of the sections is able to combine with one another to form the pole (10). A lower-most section (11) is provided with a shovel tip (12) so that the pole (10) can be easily inserted into the ground. An upper-most section (13) of the pole (10) is arcuate for mounting a lamp (14) thereon. The solar photo-voltaic panel battery (20) is adjustably connected to the pole (10) via a securing device. A securing device includes a fixing plate (21) firmly connected to a side of the solar battery (20), a pivotal plate (22) pivotally connected to the fixing plate (21) and a locking screw (23) applied to secure two halves of a ring (24) to each other.

The securing device can connect the solar photo-voltaic panel battery (20) adjustably to the pole (10) so that not only is the position of the solar battery (20) adjustable, but also the angle of the solar photo-voltaic panel battery (20) relative to the ground is adjustable so as to allow the solar photo-voltaic panel battery (20) to receive maximum available solar energy at any time.

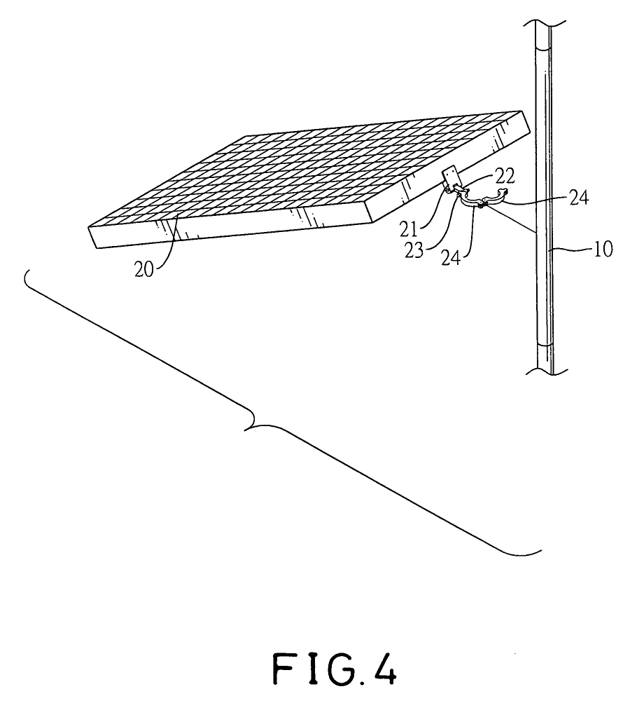

With reference to FIGS. 1 and 4, except the lower-most section (11) and the upper-most section (13) of the pole (10), each of the sections is provided with a threaded hole (161) defined in a lower end of the section and a threaded tip (16) formed on an upper end thereof so that every one of the sections is able to be combined with one another via inserting the threaded tip (16) into a corresponding threaded hole (161) of an adjacent section of the pole (10).

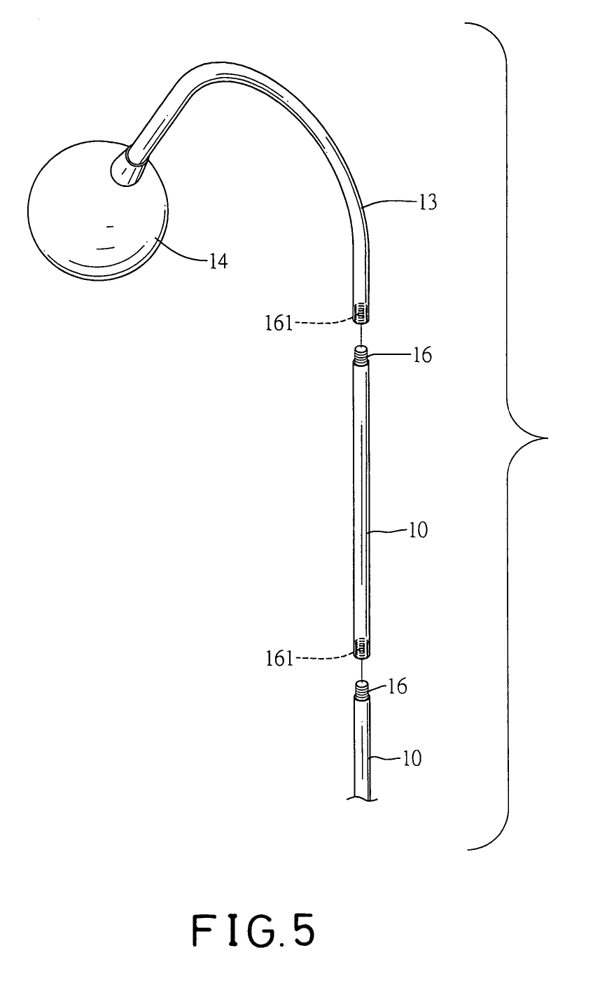

With reference to FIGS. 1 and 5, except the lower-most section (11) and the upper-most section (13) of the pole (10), each of the remaining sections is provided with through holes (17, 18) respectively defined in a lower end and an upper end of the section, a connector (19) provided between the lower end and the upper end of two adjacent sections of the pole (10) and including connection holes (191) defined therein corresponding to the through holes (17,18) of the two adjacent sections and screws (192) extending into the through holes (17,18) and the connection holes (191) when the connection holes (191) are aligned with the through holes (17,18) in the lower end and the upper end of two adjacent sections of the pole (10) such that each section of the pole (10) can be combined with another via the connector (19).

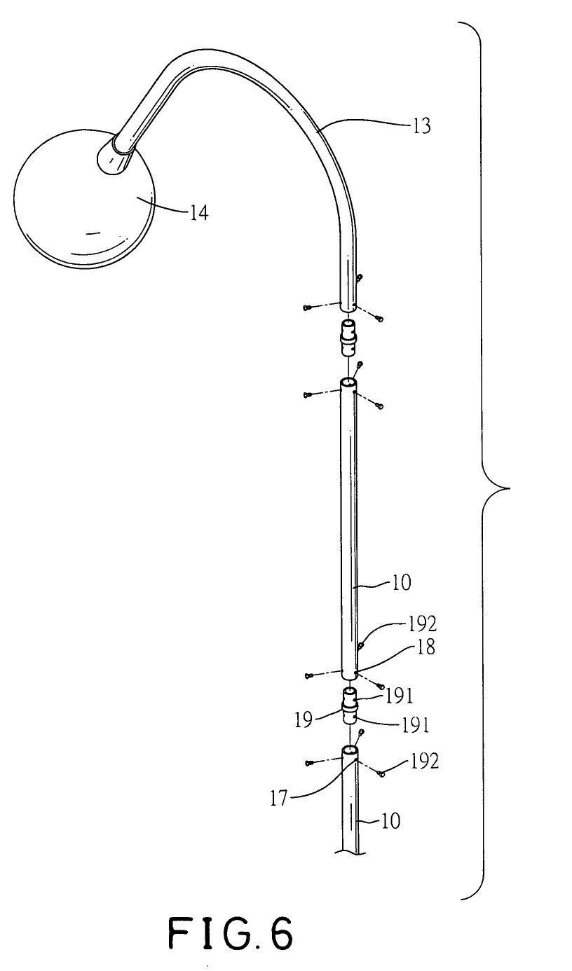

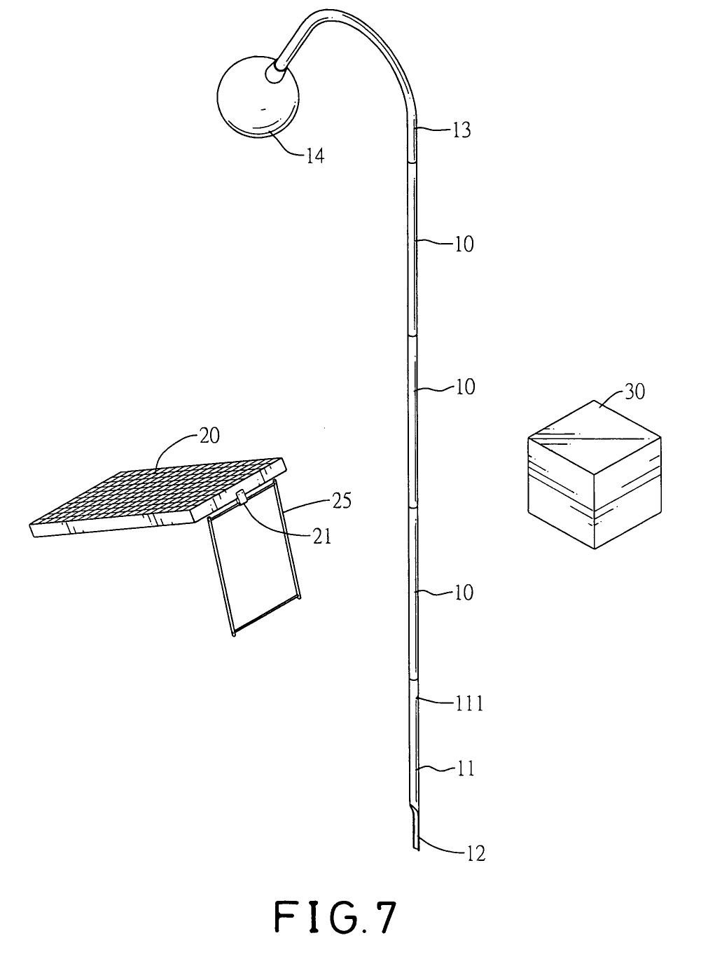

With reference to FIGS. 6 and 7, the solar photo-voltaic panel battery (20) further includes a frame (25) pivotally connected to a side of the solar photo-voltaic panel battery (20) so that the frame (25) is able to support the solar photo-voltaic panel battery (20) on the ground. Furthermore, the control box (30) is electrically connected to the solar photo-voltaic panel battery (20) via wires (not shown) and the solar photo-voltaic panel battery (20) is able to provide electricity to the light bulb of the solar photo-voltaic panel light structure.

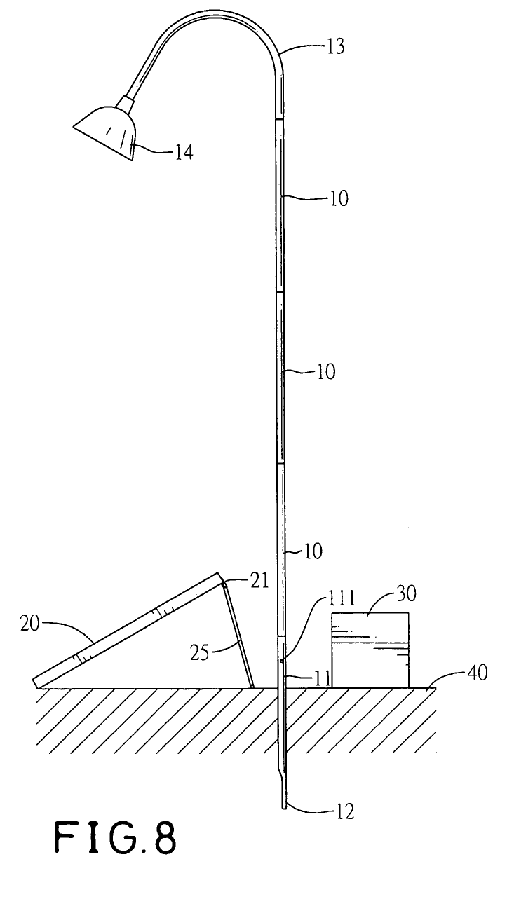

With reference to FIG. 8, when the shovel tip (12) on the lower end of the pole (10) is to penetrate the ground of a certain soil type, a handle (112) is able to extend into a radial hole (111) defined through the pole (10) to add force to the pole (10).

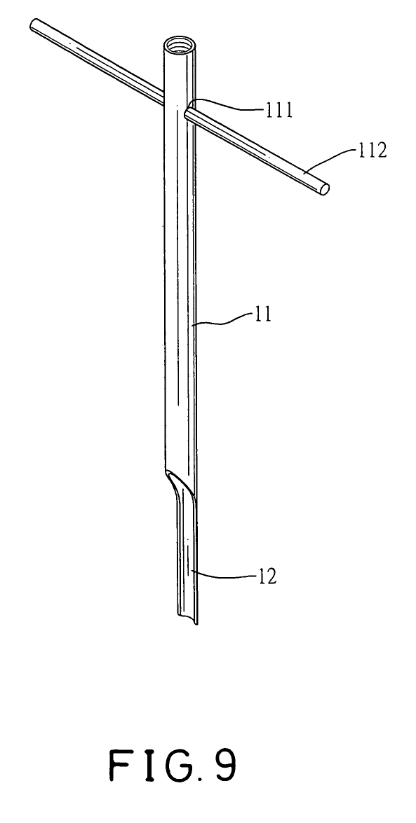

Referring to FIG. 9, there is shown a solar light according to a second embodiment of the present invention. The second embodiment is similar to the first embodiment except including a lamp 15 instead of the lamp 14.

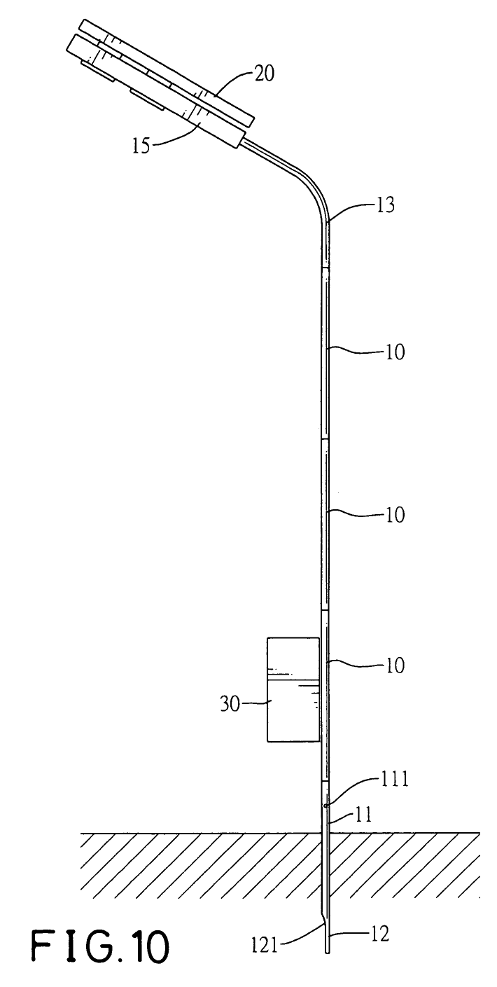

Referring to FIG. 10, there is shown a solar light according to a third embodiment of the present invention. The third embodiment is similar to the second embodiment except two things. Firstly, there is used a spike (121) instead of the shovel tip 12 for penetration into a different soil structure. Secondly, the solar photo-voltaic panel battery (20) may be directly connected to the lamp (15) to reduce blocking of the light from the solar light.

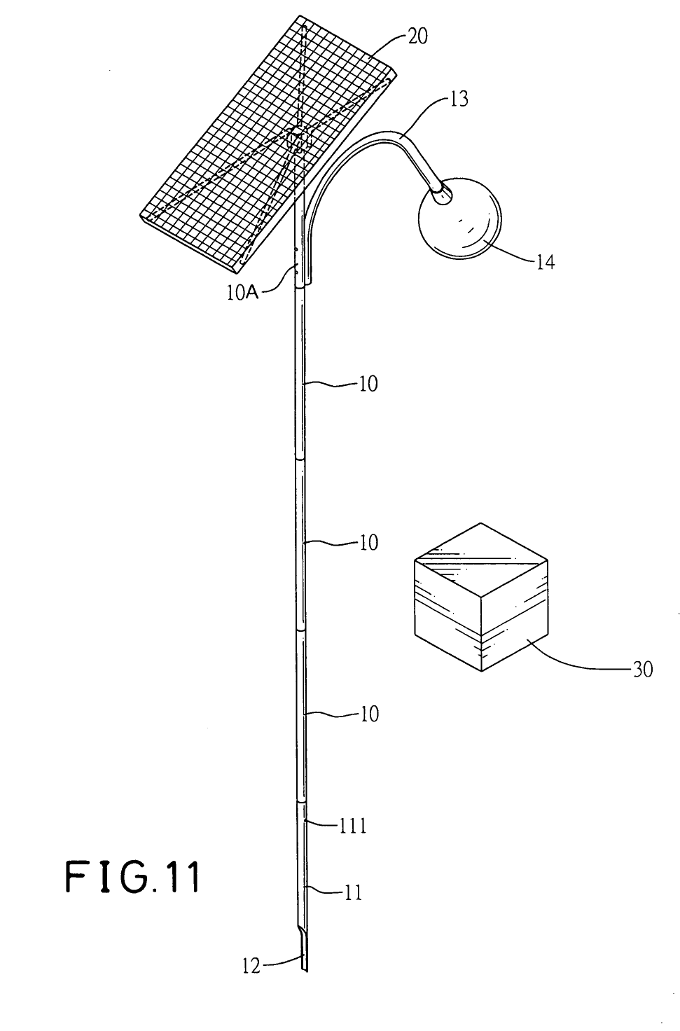

With reference to FIG. 11, there is shown a solar light according to a fourth embodiment of the present invention. The fourth embodiment is similar to the first embodiment except including an extension (10A) extended from the pole (10) and adjacent to the upper-most section (13) to support the solar photo-voltaic panel battery (20).

It is concluded that because the pole (10) is sectioned, the operator is able to easily transport the entire set of solar light structure. Also, due to the pole being sectioned, the operator is able to assemble the sectioned pole for himself.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A solar photo-voltaic panel light structure comprising:
a sectioned pole comprising a lamp formed on a upper end thereof and a foot formed on a lower end thereof to facilitate erection of the pole in the ground;
a solar photo-voltaic panel battery adjustably connected to the pole; and
a control box electrically connected to the solar photo-voltaic panel battery so that the solar photo-voltaic panel battery is able to provide electricity to the lamp.

2. The solar photo-voltaic panel light structure as claimed in claim 1 comprising a securing device for adjustably connecting the solar photo-voltaic panel battery to the pole, wherein the securing device includes a fixing plate firmly connected to a side of the solar photo-voltaic panel battery, a pivotal plate pivotally connected to the fixing plate and a locking screw for interconnecting two halves of a ring put around the pole.

3. The solar photo-voltaic panel light structure as claimed in claim 1, wherein the foot is formed as a shovel.

4. The solar photo-voltaic panel light structure as claimed in claim 1, wherein the foot is formed as a spike.

5. The solar photo-voltaic panel light structure as claimed in claim 3, wherein the pole is composed of multiple sections, wherein except a lower-most section and an upper-most section, each of the sections is provided with a threaded hole defined in a lower end of the section and a threaded tip formed on a upper end of the section corresponding to one of the threaded holes such that the threaded tip can be driven into the corresponding threaded hole to secure two adjacent sections of the pole.

6. The solar photo-voltaic panel light structure as claimed in claim 4, wherein the pole is composed of multiple sections and except a lower-most section and an upper-most section, each of remaining sections is provided with a threaded hole defined in a lower end of the section and a threaded tip formed on a upper end of the section corresponding to one of the threaded holes such that the threaded tip is able to be extended into the corresponding threaded hole to interconnect two adjacent sections of the pole.

7. The solar photo-voltaic panel light structure as claimed in claim 3, wherein the pole is composed of multiple sections and except a lower-most section and an upper-top most section, each of remaining sections is provided with through holes respectively defined in a lower end and a upper end of the section, a connector provided between the lower end and the upper end of two adjacent sections of the pole and comprising connection holes defined corresponding to the through holes of the two adjacent sections and screws extending into the through holes and the connection holes when the connection holes are aligned with the through holes in the lower end and the upper end of two adjacent sections of the pole such that each section of the pole is able to combine with another via the connector.

8. The solar photo-voltaic panel light structure as claimed in claim 4, wherein the pole is composed of multiple sections, wherein except the lower most section and the top most section of the pole, each of the sections is provided with through holes respectively defined in a lower end and a upper end of the section, a connector provided between the lower end and the upper end of two adjacent sections of the pole and comprising connection holes defined corresponding to the through holes of the two adjacent sections and screws extending into the through holes and the connection holes when the connection holes are aligned with the through holes in the lower end and the upper end of two adjacent sections of the pole such that each section of the pole is able to combine one another via the connector.

9. A solar photo-voltaic panel light structure comprising:
a sectioned pole comprising a lamp formed on a upper end thereof and a foot formed on a lower end thereof to facilitate erecting the pole in the ground;
a solar photo-voltaic panel battery placed on the ground; and
a control box electrically connected to the solar photo-voltaic panel battery so that the solar photo-voltaic panel battery is able to provide electricity to the lamp.

10. The solar photo-voltaic panel light structure as claimed in claim 9, wherein the solar photo-voltaic panel battery includes a frame pivotally connected to a side of the solar photo-voltaic panel battery so that the solar battery is able to be supported by the frame and placed on the ground.

11. The solar photo-voltaic panel light structure as claimed in claim 10, wherein the foot is shaped as a shovel.

12. The solar photo-voltaic panel light structure as claimed in claim 10, wherein the foot is formed as a spike.

13. The solar photo-voltaic panel light structure as claimed in claim 11, wherein the pole is composed of multiple sections and except a lower-most section and an upper-most section, each of remaining sections is provided with a threaded hole defined in a lower end of the section and a threaded tip formed on a upper end of the section corresponding to one of the threaded holes such that the threaded tip is able to be extended into the corresponding threaded hole to secure two adjacent sections of the pole.

14. The solar photo-voltaic panel light structure as claimed in claim 12, wherein the pole is composed of multiple sections and except a lower-most section and an upper-most section, each of remaining sections is provided with a threaded hole defined in a lower end of the section and a threaded tip formed on a upper end of the section corresponding to one of the threaded holes such that the threaded tip is able to be extended into the corresponding threaded hole to secure two adjacent sections of the pole.

15. The solar photo-voltaic panel light structure as claimed in claim 11, wherein the pole is composed of multiple sections and except a lower-most section and an upper-most section, except the lower most section and the top most section of the pole, each of remaining sections is provided with through holes respectively defined in a lower end and a upper end of the section, a connector provided between the lower end and the upper end of two adjacent sections of the pole and comprising connection holes defined corresponding to the through holes of the two adjacent sections and screws extending into the through holes and the connection holes when the connection holes are aligned with the through holes in the lower end and the upper end of two adjacent sections of the pole such that each section of the pole is able to combine with another via the connector.

16. The solar photo-voltaic panel light structure as claimed in claim 12, wherein the pole is composed of multiple sections and except a lower most section and a top most section, except the lower most section and the top most section of the pole, each of remaining sections is provided with through holes respectively defined in a lower end and a upper end of the section, a connector provided between the lower end and the upper end of two adjacent sections of the pole and comprising connection holes defined corresponding to the through holes of the two adjacent sections and screws extending into the through holes and the connection holes when the connection holes are aligned with the through holes in the lower end and the upper end of two adjacent sections of the pole such that each section of the pole is able to combine with another via the connector.
